(19) United States
(12) Patent Application Publication
(10) Pub. No.: US 2026/0300750 A1
(43) Pub. Date: Oct. 1, 2026

(54) LEARNING DEVICE AND LEARNING METHOD FOR MILITARY DECISION-MAKING BASED ON OFFLINE REINFORCEMENT LEARNING

(71) Applicant: FOUNDATION OF SOONGSIL UNIVERSITY-INDUSTRY COOPERATION, Seoul (KR)

(72) Inventors: MINHAE KWON, Seoul (KR); JAEHWI LEE, Seoul (KR); CHANIN EOM, Seoul (KR)

(21) Appl. No.: 19/297,210

(22) Filed: Aug. 12, 2025

(30) Foreign Application Priority Data
Mar. 27, 2025 (KR) 10-2025-0039538
May 20, 2025 (KR) 10-2025-0065570

(51) Int. Cl. G06N 3/092; G09B 9/00

(52) U.S. Cl. CPC G06N 3/092; G09B 9/003

(57) ABSTRACT

A learning device is for military decision-making based on offline reinforcement learning. The learning device includes a data acquisition module configured to acquire enemy-related information and friendly-related information at each time step in each episode, a data processing module configured to generate a data set including a state, an action, and a reward based on the enemy-related information and friendly-related information of each time step, and a learning module configured to train a neural network based on reinforcement learning by inputting a data set including the state, action, and reward for each time step.

### CROSS-REFERENCE TO RELATED APPLICATIONS AND CLAIM OF PRIORITY

This application claims the benefit under 35 USC § 119 of Korean Patent Application Nos. 10-2025-0039538 filed on Mar. 27, 2025 and 10-2025-0065570 filed on May 20, 2025, in the Korean Intellectual Property Office, the entire disclosure of which is incorporated herein by reference for all purposes.

### BACKGROUND

### 1. Technical Field

Embodiments of the present disclosure relate to learning techniques for military decision-making based on offline reinforcement learning.

### 2. Description of Related Art

Recently, as the complexity of military operations has increased, artificial intelligence-based commander decision-making support technology is becoming important. In this situation, the weapon-target assignment (WTA) problem is closely linked to various defense technologies such as command decision AI system, intelligent battlefield awareness and judgment, and autonomous tactical decision-making, and plays a key role in establishing a digital defense system. The weapon-target assignment (WTA) problem aims to effectively allocate friendly weapon resources while inflicting effective damage on the enemy. In order to achieve the strategic goal of the commander, resource optimization at the target level desired by the commander should be made, not simply maximizing damage, and thus the importance of the weapon-target assignment problem is being emphasized in modern military operations.

To solve the weapon-target assignment (WTA) problem, an exact algorithm, which searches all possible solutions to derive accurate results, has been used in the past, but it has limitations due to computational complexity. Therefore, heuristic-based methods, which are approximate methods that may increase computational efficiency and provide useful solutions, have been utilized, but in reality, difficulties still exist in decision-making in complex and dynamic battlefield environments.

In this situation, methods based on reinforcement learning has begun to be introduced to the weapon-target assignment problem. Reinforcement learning is a method of learning a policy through interaction with the environment, and is a method of maximizing long-term rewards by selecting an optimal action in a given state. Meanwhile, online reinforcement learning has limitations in that it requires real-time interaction, which may cause cost or safety issues, whereas offline reinforcement learning has the advantage of being able to learn without additional interaction with the environment by utilizing pre-collected data. Therefore, an offline reinforcement learning method is required for optimal decision-making in a military environment.

Examples of related art include Korean Registered Patent Publication No. 10-2480564 (2022 Dec. 22).

### SUMMARY

Embodiments of the present disclosure are intended to provide a novel learning technique for military decision-making based on offline reinforcement learning.

A learning device according to an embodiment of the present disclosure is a learning device for military decision-making based on offline reinforcement learning, the learning device including a data acquisition module configured to acquire enemy-related information and friendly-related information at each time step in each episode, a data processing module configured to generate a data set including a state, an action, and a reward based on the enemy-related information and friendly-related information of each time step, and a learning module configured to train a neural network based on reinforcement learning by inputting a data set including the state, action, and reward for each time step.

Information on the state may include one or more of a defense level according to a state of an enemy unit, a distance between the enemy unit and a friendly unit, a health of the enemy unit, a desired effect of a commander for the corresponding episode, an ammunition supply rate of each weapon of the friendly unit, and an available ammunition quantity for each weapon of the friendly unit, information on the action may include one or more of a type of friendly unit performing the action, an ammunition type selected by the friendly unit, and an ammunition usage amount selected by the friendly unit, and the data processing module may be configured to set a reward for the current time step based on information on the state and action of the current time step and information on the state of the next time step.

The data processing module may be configured to set the reward based on one or more preset reward functions, the reward functions may include a first reward function, and the first reward function may be prepared to receive a reward or a penalty based on a comparison between the health of the enemy unit and a desired health of the enemy unit.

The first reward function may be prepared so that, when the health of the enemy unit of the next time step exceeds the desired health of the enemy unit, a reward is given in proportion to a difference between the health of the enemy unit and the desired health of the enemy unit, and may be prepared so that, if the desired health of the enemy unit exceeds the health of the enemy unit of the next time step, but the difference between the health of the enemy unit and the desired health of the enemy unit exceeds a preset allowable margin, a penalty is given as much as the allowable margin is exceeded.

The data processing module may be configured to calculate the health of the enemy unit of the next time step based on the health of the enemy unit of the current time step, the ammunition usage amount of an ammunition type selected by the friendly unit of the current time step, and a health reduction ratio of the enemy unit caused by the friendly unit.

The reward functions may further include a second reward function, and the second reward function may be prepared so that a penalty is given in proportional to the ammunition usage amount of the friendly unit of the current time step.

The reward functions may further include a third reward function, and the third reward function may be prepared so that when the final health of the enemy unit at the end of the episode falls below the desired health of the enemy unit, a penalty is given thereto.

The learning device may further include an evaluation module configured to evaluate performance of the trained neural network through one or more preset evaluation metrics.

The evaluation metrics may include a first evaluation metric, and the first evaluation metric may be an episode achievement rate that determines whether an episode has been achieved depending on whether a difference between the final health of the enemy unit at the end of each episode and the desired health of the enemy unit is within the preset allowable margin.

The evaluation metrics may include a second evaluation metric, and the second evaluation metric may be a desired health error rate based on a difference between the desired health of the enemy unit per episode and the final health of the enemy unit.

The evaluation metrics may include a third evaluation metric, and the third evaluation metric may be an ammunition usage cost according to an amount of ammunition used by the friendly unit per episode.

The evaluation metrics may include a fourth evaluation metric, and the fourth evaluation metric may be an ammunition efficiency calculated based on whether the episode determined depending on whether a difference between the final health of the enemy unit at the end of each episode and the desired health of the enemy unit is within the preset allowable margin and the ammunition usage amount of the friendly unit upon achievement of the episode.

The learning device may further include an evaluation module configured to evaluate performance of the trained neural network through preset first to fourth evaluation metrics, and the first evaluation metric may be an episode achievement rate that determines whether an episode has been achieved depending on whether a difference between the final health of the enemy unit at the end of each episode and the desired health of the enemy unit is within a preset allowable margin, the second evaluation metric may be a desired health error rate based on a difference between the desired health of the enemy unit per episode and the final health of the enemy unit, the third evaluation metric may be an ammunition usage cost according to an amount of ammunition used by the friendly unit per episode, and the fourth evaluation metric may be an ammunition efficiency calculated based on whether the episode determined depending on whether a difference between the final health of the enemy unit at the end of each episode and the desired health of the enemy unit is within the preset allowable margin and the ammunition usage amount of the friendly unit upon achievement of the episode.

A learning method according to an embodiment of the present disclosure is a method that is performed on a computing device that includes one or more processors and a memory storing one or more programs executed by the one or more processors and is for military decision-making based on offline reinforcement learning, the learning method including acquiring enemy-related information and friendly-related information at each time step in each episode, generating a data set including a state, an action, and a reward based on the enemy-related information and friendly-related information of each time step, and training a neural network based on reinforcement learning by inputting a data set including the state, action, and reward for each time step.

### BRIEF DESCRIPTION OF THE DRAWINGS

FIG. 1 is a diagram schematically illustrating a battlefield scenario for military decision-making according to an embodiment of the present disclosure.

FIG. 2 is a diagram showing a configuration of a learning device for military decision-making based on offline reinforcement learning according to an embodiment of the present disclosure.

FIG. 3 is a diagram illustrating information on an action in an embodiment of the present disclosure.

FIG. 4 is a flowchart for describing a learning method for military decision-making based on offline reinforcement learning according to an embodiment of the present disclosure.

FIG. 5 is a block diagram for illustratively describing a computing environment including a computing device suitable for use in exemplary embodiments.

### DETAILED DESCRIPTION

Hereinafter, specific embodiments of the present invention will be described with reference to the drawings. The following detailed description is provided to facilitate a comprehensive understanding of the methods, apparatuses, and/or systems described herein. However, this is only an example and the present invention is not limited thereto.

In describing embodiments of the present invention, if it is determined that a specific description of a related known function of the preset invention may unnecessarily obscure the gist of the present invention, the detailed description thereof will be omitted. The terms described below are terms defined in consideration of the functions in the present invention, and vary depending on the intention or custom of the user or operator. Therefore, the definition should be made based on the contents throughout this specification. The terminology used in the detailed description is for the purpose of describing embodiments of the present invention only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In addition, the terms first, second, etc. may be used to describe various components, but the components should not be limited by the terms. The terms may be used for the purpose of distinguishing one component from another component. For example, without departing from the scope of the present invention, a first component may be referred to as a second component, and similarly, a second component may also be referred to as a first component.

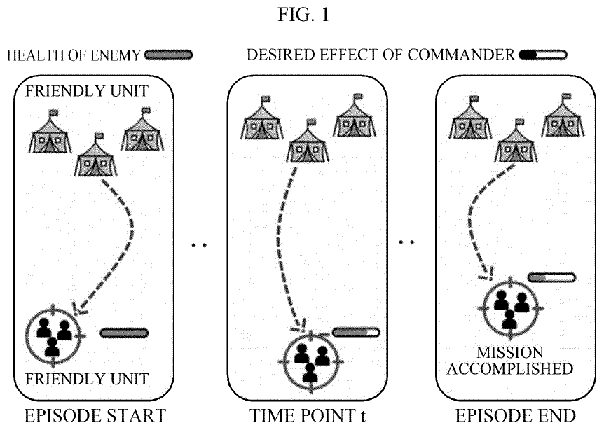

In the disclosed embodiment, a battlefield situation for military decision-making considers a dynamically changing battlefield situation. FIG. 1 is a diagram schematically illustrating a battlefield scenario for military decision-making according to an embodiment of the present disclosure. Referring to FIG. 1, friendly units and enemy units may be initially deployed at random locations in a battlefield environment. Each episode lasts Tₑ time, the total number of episodes is E, and each episode is independent. The enemy units may randomly move their locations within a certain range at each time point in the episode. Friendly units are represented as [symbol] ={u₁, u₂, . . . u_{U}}, and each unit has ammunition types consisting of a set of [symbol] ={w₁, w₂, . . . w_{W}}. An effect desired by the commander may be set for each episode.

Here, the goal of military decision-making is to efficiently select the type and consumption amount of ammunition at the end of the episode while ensuring that a damage inflicted on the enemy matches a predefined effect desired by the commander (i.e., a damage to the enemy desired by the commander). In other words, the goal of military decision-making is to efficiently select the type and consumption amount of the ammunition so that the damage inflicted on the enemy matches the effect desired by the commander.

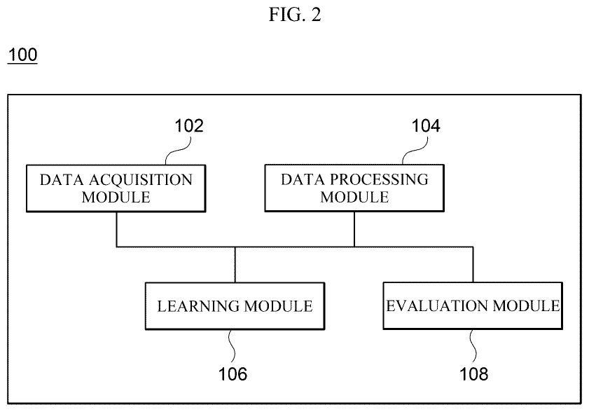

FIG. 2 is a diagram showing a configuration of a learning device for military decision-making based on offline reinforcement learning according to an embodiment of the present disclosure.

Referring to FIG. 2, a learning device 100 may include a data acquisition module 102, a data processing module 104, a learning module 106, and an evaluation module 108. The learning device 100 may be configured to perform decision-making to efficiently use the resources of friendly units while achieving the desired effect of a commander in a battlefield situation, based on offline reinforcement learning.

The data acquisition module 102 may acquire pre-collected data to train a neural network based on reinforcement learning. The data acquisition module 102 may acquire pre-collected data from a memory of the distributional reinforcement learning device 100 or an external database, but is not limited thereto.

In an embodiment, the data acquisition module 102 may acquire data on a simulator that implements a military operation environment. The data acquisition module 102 may acquire enemy-related information and friendly-related information for each time step in each episode.

In an embodiment, the enemy-related information may include a type of the enemy unit, a location of the enemy unit, a health of the enemy unit, and a state of the enemy unit. The friendly-related information may include a type of the friendly unit, a location of the friendly unit, a type of weapon used by the friendly unit, and an amount of ammunition used by the friendly unit.

The data processing module 104 may process the data acquired by the data acquisition module 102 into a form suitable for training. In an embodiment, the data processing module 104 may configure a data set to be used for reinforcement learning based on enemy-related information and friendly-related information acquired for each time step. In this case, each data set may include information on a state, an action, and a reward.

In an embodiment, the data processing module 104 may generate information on the state of each time step (time point t) based on the enemy-related information and friendly-related information acquired for each time step. Here, the information on the state may include a defense level according to the state of the enemy unit, a distance between the enemy unit and the friendly unit, a health of the enemy unit, a desired effect of the commander for the corresponding episode, an ammunition supply rate of each weapon of the friendly unit, and an available ammunition quantity for each weapon of the friendly unit. In an embodiment, information on a state sₜ at time step t in the corresponding episode may be expressed as the following Equation 1.

$${S}_{t} = {[ {v}_{e} , {k}_{e} {b}_{e} , {c}_{e} , {d}_{t} , {h}_{t} , {l}_{t} ]}^{T} \qquad Equation 1$$

vₑ: desired effect of commander
kₑ: type of enemy unit
bₑ: defense level according to state of enemy unit
cₑ: ammunition supply rate per weapon of friendly unit
dₑ: distance between friendly unit and enemy unit at time point t
hₜ: health of enemy unit at time point t
lₜ: available ammunition quantity for each weapon per friendly unit at time point t (remaining ammunition quantity)

In addition, the data processing module 104 may generate information on the action of each time step based on the friendly unit-related information acquired for each time step.

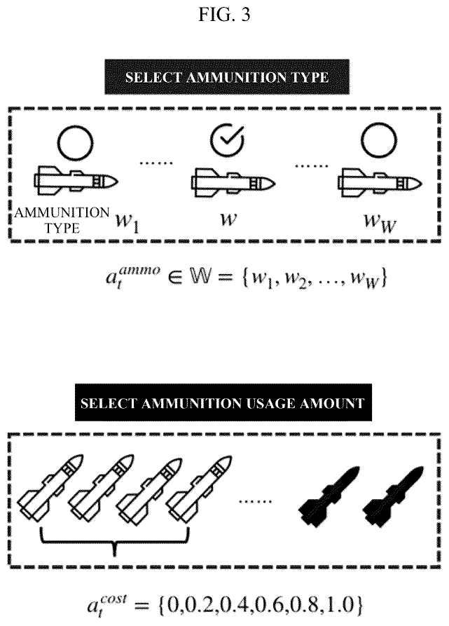

Here, the information on the action may include the type of ammunition (weapon type) selected by the friendly unit and an ammunition usage amount selected by the friendly unit, as shown in FIG. 3. In this case, the friendly unit may perform an action of selecting the type of ammunition from among the ammunition available (i.e., in stock) at the corresponding time step. The ammunition usage amount may mean an ammunition usage rate for the type of ammunition selected by the friendly unit. The ammunition usage ratio may be selected from, for example, {0, 0.2, 0.4, 0.6, 0.8, 1.0}. In an embodiment, information on an action aₜ at time step t may be expressed as the following Equation 2.

$${a}_{t} = \{ {a}_{t}^{ammo} , {a}_{t}^{cost} \} \qquad Equation 2$$

$${a}_{t}^{ammo}$$

type of weapon selected by friendly unit at time point t

$${a}_{t}^{cost}$$

ammunition usage rate of friendly unit at time point t

Meanwhile, the actual number of ammunitions used (ammunition usage amount) for the w weapon of a u-th friendly unit at time point t may be defined as in the following Equation 3 based on the ammunition supply rate for the corresponding weapon w.

$$α \times {c}_{e , u , w} \times {a}_{t}^{cost} \qquad Equation 3$$

α: parameter that controls maximum number of ammunitions available per unit time
c_{c,u,w}: ammunition supply rate for w weapon of u-th friendly unit

According to Equation 3, the friendly unit u may use an amount of up to α×c_{c,u,w} amount of ammunition for the corresponding weapon w at time point t. In addition, based on Equation 3, the remaining number of ammunitions (ammunition stock amount) l_{t+1,u,w} for the weapon w of the friendly unit u at time point (t+1) may be calculated using the following Equation 4.

$${l}_{t + 1 , vw} = {l}_{t , u , w} - ( α \times {c}_{e , v , w} \times {a}_{t}^{cost} ) \qquad Equation 4$$

l_{t,u,w}: number of remaining ammunitions for weapon w of friendly unit u at time point t

That is, the number of remaining ammunitions for the weapon w of the friendly unit u at time point (t+1) may be calculated by a difference between the number of ammunitions for the weapon w used at time point t and the number of remaining ammunitions for the weapon w at time point t. In Equation 4, the total number of ammunitions of the weapon used until the end time point of the episode Tₑ cannot exceed the initial remaining quantity of the weapon, and when the number of ammunition actually determined to be used at a particular time point is greater than the remaining quantity of ammunition at that time point, it may be restricted to select up to the remaining quantity of ammunition at that time point.

In addition, the data processing module 104 may set a reward for the current time step based on information on the state and action of the current time step and information on the state of the next time step. In this case, a reward rt at time point t in the episode may be expressed as in the following Equation 5.

$${r}_{t} = {\sum }_{i = 1}^{3} {η}_{i} {R}_{t , i} \qquad Equation 5$$

ηᵢ: weight set to i-th reward function
R_{t,i}: i-th reward function at time point t

Specifically, a reward function R may include a first reward function R_{t,1} to a third reward function R_{t,3}. In an embodiment, the first reward function R_{t,1} may be a reward function that receives a reward or penalty based on a comparison between the health of the enemy unit and the health of the enemy unit desired by the commander (the desired health of the enemy unit).

In an embodiment, the first reward function R_{t,1} may be prepared so that, when the health of the enemy unit hₜ₊₁ at time (t+1) due to an attack by the friendly unit at time point t exceeds the desired health of the enemy unit, a reward is given in proportion to a difference between the health of the enemy unit hₜ at time point t and the health of the enemy unit hₜ₊₁ at time point (t+1).

In addition, the first reward function R_{t,1} may be prepared so that, when the desired health of the enemy unit exceeds the health of the enemy unit, but a difference between the health of the enemy unit and the desired health of the enemy unit exceeds a preset allowable margin, a penalty is given as much as the preset allowable margin is exceeded. Even if the desired health of the enemy unit exceeds the health of the enemy unit, when the difference between the health of the enemy unit and the desired health of the enemy unit is within the preset allowable margin, a penalty may not be given. The first reward function R_{t,1} may be expressed by Equation 6.

$${R}_{t , 1} = \{ \begin{matrix}{h}_{t} - {h}_{t + 1} , & {h}_{{v}_{e}} < {h}_{t + 1} \\ 0 , & {h}_{{v}_{e}} - ϵ < {h}_{t + 1} \leq {h}_{{v}_{e}} \\ {h}_{t + 1} - {h}_{{v}_{e}} , & {h}_{t + 1} < {h}_{{v}_{e}} - ϵ\end{matrix} \qquad Equation 6$$

hₜ: health of the enemy unit at time point t
hₜ₊₁: health of enemy unit at time point t+1
hᵥ_{ₑ}: desired health of enemy unit
ϵ: preset allowable margin

Here, the health of the enemy unit hₜ₊₁ at time point (t+1) is set by an actual number of ammunition used for the w weapon of the u-th friendly unit at time point t and a health reduction ratio of the enemy unit, which may be expressed as the following Equation 7.

$${h}_{t + 1} = {h}_{t} \times {( 1 - {p}_{t} )}^{α \times {c}_{e , u , w} \times {a}_{t}^{cost}} \qquad Equation 7$$

$$Here ,$$

$${( 1 - {p}_{t} )}^{α \times {c}_{e , u , w} \times {a}_{t}^{cost}}$$

represents the health reduction ratio of the enemy unit due to the u-th friendly unit at time point t. That is, the health reduction ratio of the enemy unit may be set based on a damage amount pₜ of the enemy unit and the ammunition usage amount of the friendly unit.

The damage amount pₜ of the enemy unit may be determined based on the defense level of the enemy unit, a damage constant according to the type of ammunition selected by the friendly unit per type of enemy unit, and a damage function according to the distance between the friendly unit and the enemy unit. The damage amount pₜ of the enemy unit may be expressed as the following Equation 8.

$${p}_{t} = N ( \overline{p} \times {b}_{e} \times δ ( {k}_{e} , {a}_{t}^{ammo} ) \times ζ ( {d}_{t} ) , σ ) \qquad Equation 8$$

N: Gaussian normal distribution function
p̅: damage constant
bₑ: defense level according to state of enemy unit

$$δ ( {k}_{e} , {a}_{t}^{ammo} )$$

damage constant according to type of ammunition selected by friendly unit per type of enemy unit
ζ(dₜ): damage function according to distance dₜ between friendly unit and enemy unit at time point t
σ: standard deviation for Gaussian normal distribution

A second reward function R_{t,2} may be a reward function that receives a penalty according to the ammunition usage amount of the friendly unit. The second reward function R_{t,2} may receive a penalty in proportion to the ammunition usage amount used by friendly units to attack enemy units. The second reward function R_{t,2} may be expressed as the following Equation 9.

$${R}_{t , 2} = - α \times {c}_{e , u , w} \times {a}_{t}^{cost} \qquad Equation 9$$

A third reward function R_{t,3} may be a reward function that receives a penalty when the total amount of damage inflicted by friendly units to enemy units falls below the health level desired by the commander. In other words, when the final health of the enemy units at the end of the episode falls below the health of the enemy units desired by the commander (the desired health of the enemy units), the third reward function R_{t,3} may receive a penalty. The third reward function R_{t,3} may be expressed as the following Equation 10.

$${R}_{t , 3} = \{ \begin{matrix}- 1 , & {h}_{{T}_{e}} > {{h}_{v}}_{e} \\ 0 , & otherwise\end{matrix} \qquad Equation 10$$

h_{T}_{ₑ}: final health of enemy unit at the end of episode

The data processing module 104 may configure {state (sₜ), action (aₜ), reward (rₜ)} for each time step in each episode as one data set. The data processing module 104 may transmit the data set composed of {state (sₜ), action (aₜ), reward (rₜ)} per each time step to the learning module 106. In this way, the data processing module 104 may process the data acquired by the data acquisition module 102 so that the learning module 106 may perform reinforcement learning to configure a data set.

The learning module 106 may include a neural network based on reinforcement learning. The learning module 106 may train the neural network using the data set received from the data processing module 104.

In an embodiment, the learning module 106 may include a neural network based on reinforcement learning, which is composed of a value network, a critic network, and an actor network. Here, the value network may take a state as input from among the data set consisting of {state (sₜ), action (aₜ), reward (rₜ)} and output a prediction value V(sₜ) of a specific state. The critique network may take a state and an action as inputs and output a prediction value Q(sₜ, aₜ) for the action at a specific state. The actor network may take a state as input and output an action π(sₜ) according to the current policy.

The learning module 106 may perform training to predict an optimal action(an action of the friendly unit selecting the type of ammunition and the action of determining the ammunition usage amount) in a given state by using the value network and the critic network. In this case, the learning module 106 may perform training to find the optimal policy that maximizes the reward.

Specifically, the learning module 106 may train the value network so that the difference between the prediction value V(sₜ) output by the value network and a preset target value is minimized. In this case, the target value may be the prediction value Q(sₜ, aₜ) output by the critic network. That is, the value network may be trained by a first loss function according to the following Equation 11.

$${\text{?}}_{V} ( ϕ ) = {𝔼}_{( {s}_{t} , {a}_{t} ) ∼ D} [ {L}_{τ}^{2} ( {Q}_{θ} ( {s}_{t} , {a}_{t} ] - V ( {s}_{t} , ) ] \qquad Equation 11$$

L_{τ}: Expectile Loss

The learning module 106 may train the critic network so that the difference between the prediction value Q(sₜ, aₜ) output by the critic network and the preset target value is minimized. In this case, the target value may be a value obtained by adding the reward rt in the data set and an output value V(sₜ₊₁) of the value network for a state sₜ₊₁ of the next time step. That is, the critic network may be trained by a second loss function according to the following Equation 12.

$${{\text{?}}_{Q} ( θ ) = {𝔼}_{( {s}_{t} , {a}_{t} , {r}_{t} , {s}_{t + 1} ) ∼ D} [ ( ( {r}_{t} + γ V ( {s}_{t + 1} ) ) − Q ( {s}_{t} , {a}_{t} ) ) )}^{2} ] \qquad Equation 12$$

γ: preset depreciation rate

The learning module 106 may train the actor network so that a difference between the action π(sₜ) predicted by the actor network and the action aₜ in the data set is minimized. In this case, the learning module 106 may use an advantage function to weight to follow an action having a high value. The advantage function may be set as a difference between the prediction value Q(sₜ, aₜ) of the critic network and the prediction value V(sₜ) of the value network. That is, the actor network may be trained by a third function according to the following Equation 13.

$${\text{?}}_{π} ( ψ ) = {𝔼}_{( {s}_{t} , {a}_{t} ) ∼ D} [ exp ( β ( Q ( {s}_{t} , {a}_{t} ) − V ( {s}_{t} ) ) ) ‖ {a}_{t} − {π ( {s}_{t} ) ‖}^{2} ] \qquad Equation 13$$

β: hyperparameter that controls sensitivity to advantage function

The evaluation module 108 may evaluate the performance of the neural network based on reinforcement learning trained by the learning module 106 through preset evaluation metrics. Here, the evaluation metrics may include an episode achievement rate (first evaluation metric), a desired health error rate (second evaluation metric), an ammunition usage cost (third evaluation metric), and an ammunition efficiency (fourth evaluation metric).

The evaluation module 108 may calculate the achievement rate for each episode. The evaluation module 108 may determine that the episode is achieved when the difference between the final health of the enemy unit at the end of the episode and the desired health of the enemy unit is within a preset allowable margin, and may determine that the episode is not achieved if the difference is outside the allowable margin. The evaluation module 108 may calculate the episode achievement rate F by the following Equation 14.

$$F = \frac{1}{E} {\sum }_{e = 1}^{E} f ( e ) \times 100 \qquad Equation 14$$

E: total number of episodes
f(e): achievement function for e-th episode

Here, the achievement function f(e) for the e-th episode may be a function for determining whether the episode is achieved depending on whether the difference between the final health of the enemy unit at the end of the episode and the desired health of the enemy unit is within the preset allowable margin. For example, when the difference is within the preset allowable margin, f(e) may be 1, and if the difference is outside the preset allowable margin, f(e) may be 0.

The evaluation module 108 may calculate the desired health error rate based on a difference between the desired health of the enemy unit due to the desired effect of the commander per each episode and the final health of the enemy unit. The evaluation module 108 may calculate the desired health error rate P through the following Equation 15.

$$P = \frac{1}{E} {\sum }_{e = 1}^{E} \frac{\vert {h}_{{T}_{e}} - {h}_{{v}_{e}} \vert}{{h}_{{v}_{e}}} \times 100 \qquad Equation 15$$

The evaluation module 108 may calculate the cost (i.e., the ammunition usage cost) according to the amount of ammunition used by the friendly unit per episode. The evaluation module 108 may calculate the ammunition usage cost C through the following Equation 16.

$$C = \frac{1}{E} {\sum }_{e = 1}^{E} {\sum }_{t = 1}^{T} ( α \times {c}_{e , u , w} \times {a}_{t}^{cost} ) \qquad Equation 16$$

The evaluation module 108 may calculate the ammunition efficiency, which indicates how efficiently friendly units consumed ammunition per each episode. The evaluation module 108 may calculate the ammunition efficiency based on the achievement function f(n) of each episode and the ammunition usage amount upon episode achievement. The evaluation module 108 may calculate ammunition efficiency H through the following Equation 17.

$$H = \frac{{\sum }_{e = 1}^{E} f ( e )}{{\sum }_{e = 1}^{E} {\sum }_{t = 1}^{T} f ( e ) \cdot ( α \times {c}_{e , u , w} \times {a}_{t}^{cost} )} \qquad Equation 17$$

The evaluation module 108 may assign an evaluation score for each of a first to fourth evaluation metrics. The evaluation module 108 may assign a higher evaluation score as the first evaluation metric (the achievement rate of the episode) is higher. The evaluation module 108 may assign a higher evaluation score as the second evaluation metric (the desired health error rate) is lower. The evaluation module 108 may assign a higher evaluation score as the third evaluation metric (the ammunition usage cost) is lower. The evaluation module 108 may assign a higher evaluation score as the fourth evaluation metric (the ammunition efficiency) is higher. The evaluation module 108 may evaluate the performance of the neural network by adding up the evaluation scores each assigned for each of the first to fourth evaluation metrics.

According to the disclosed embodiments, a decision-making policy for efficient firepower (e.g., a policy for selecting ammunition types and ammunition usage) can be determined according to the desired effect of a commander in a dynamic military environment. In addition, training can be performed by utilizing a pre-collected and processed data set without additional interaction with the real environment through offline reinforcement learning.

In this specification, the term “module” may mean a functional and structural combination of hardware for performing the technical idea of the present invention and software for operating the hardware. For example, the “module” may mean a logical unit of a given code and hardware resources for performing the given code, and does not necessarily mean physically connected code or a type of hardware.

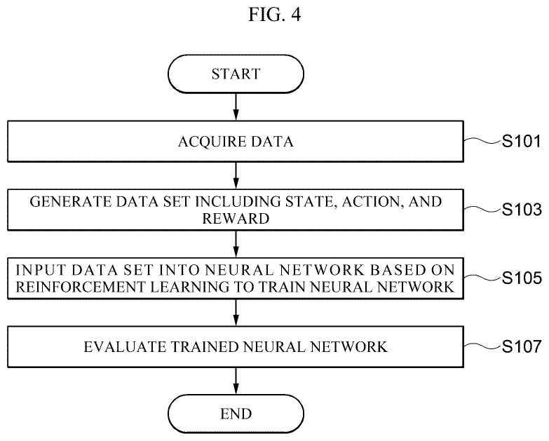

FIG. 4 is a flowchart describing a learning method for military decision-making in an offline environment according to an embodiment of the present disclosure. Although the method is described as being divided into a plurality of steps in the illustrated flowchart, at least some of the steps may be performed in a different order, performed together by being combined with other steps, omitted, performed by being divided into sub-steps and, or performed by adding one or more steps (not shown).

Referring to FIG. 4, the learning device 100 may acquire data collected in advance to train a neural network based on reinforcement learning (S 101). The learning device 100 may acquire enemy-related information and friendly-related information at each time step in each episode.

Next, the learning device 100 may generate a data set including a state, an action, and a reward per each time step based on the acquired enemy-related information and friendly-related information (S 103).

Next, the learning device 100 may input the data set including the state, the action, and the reward per each time step into the neural network based on reinforcement learning to train the neural network (S 105). The learning device 100 may train the neural network to find an optimal policy that maximizes the reward.

Next, the learning device 100 may evaluate the trained neural network using preset evaluation metrics (S 107). Here, the evaluation metrics may include the episode achievement rate, the desired health error rate, the ammunition usage cost, and the ammunition efficiency.

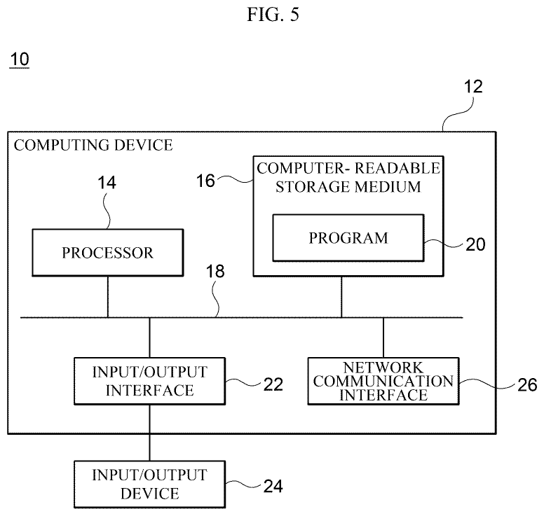

FIG. 5 is a block diagram for illustrating a computing environment 10 including a computing device suitable for use in exemplary embodiments. In the illustrated embodiment, respective components may have different functions and capabilities other than those described below, and include additional components in addition to those described below.

The illustrated computing environment 10 includes a computing device 12. In an embodiment, the computing device 12 may be the distributional reinforcement learning device 100.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the disclosed embodiments, a decision-making policy for efficient firepower (e.g., a policy for selecting ammunition types and ammunition usage) can be determined according to the desired effect of a commander in a dynamic military environment. In addition, training can be performed by utilizing a pre-collected and processed data set without additional interaction with the real environment through offline reinforcement learning.

Although representative embodiments of the present invention have been described in detail above, those skilled in the art will understand that various modifications may be made to the above-described embodiments without departing from the scope of the present invention. Therefore, the scope of the present invention should not be limited to the described embodiments, but should be defined not only by the patent claims described below but also by those equivalent to the patent claims.

What is claimed is:

1. A learning device for military decision-making based on offline reinforcement learning, comprising:
a data acquisition module configured to acquire enemy-related information and friendly-related information at each time step in each episode;
a data processing module configured to generate a data set including a state, an action, and a reward based on the enemy-related information and friendly-related information of each time step; and
a learning module configured to train a neural network based on reinforcement learning by inputting a data set including the state, action, and reward for each time step.

2. The learning device of claim 1, wherein information on the state includes one or more of a defense level according to a state of an enemy unit, a distance between the enemy unit and a friendly unit, a health of the enemy unit, a desired effect of a commander for the corresponding episode, an ammunition supply rate of each weapon of the friendly unit, and an available ammunition quantity for each weapon of the friendly unit,
information on the action includes one or more of a type of friendly unit performing the action, an ammunition type selected by the friendly unit, and an ammunition usage amount selected by the friendly unit, and
the data processing module is configured to set a reward for the current time step based on information on the state and action of the current time step and information on the state of the next time step.

3. The learning device of claim 2, wherein the data processing module is configured to set the reward based on one or more preset reward functions,
the reward functions may include a first reward function, and
the first reward function is prepared to receive a reward or a penalty based on a comparison between the health of the enemy unit and a desired health of the enemy unit.

4. The learning device of claim 3, wherein the first reward function is prepared so that, when the health of the enemy unit of the next time step exceeds the desired health of the enemy unit, a reward is given in proportion to a difference between the health of the enemy unit and the desired health of the enemy unit, and is prepared so that, if the desired health of the enemy unit exceeds the health of the enemy unit of the next time step, but the difference between the health of the enemy unit and the desired health of the enemy unit exceeds a preset allowable margin, a penalty is given as much as the allowable margin is exceeded.

5. The learning device of claim 4, wherein the data processing module is configured to calculate the health of the enemy unit of the next time step based on the health of the enemy unit of the current time step, the ammunition usage amount of an ammunition type selected by the friendly unit of the current time step, and a health reduction ratio of the enemy unit caused by the friendly unit.

6. The learning device of claim 3, wherein the reward functions further include a second reward function, and
the second reward function is prepared so that a penalty is given in proportional to the ammunition usage amount of the friendly unit of the current time step.

7. The learning device of claim 6, wherein the reward functions further include a third reward function, and
the third reward function is prepared so that when the final health of the enemy unit at the end of the episode falls below the desired health of the enemy unit, a penalty is given thereto.

8. The learning device of claim 7, wherein the learning device further includes an evaluation module configured to evaluate performance of the trained neural network through one or more preset evaluation metrics.

9. The learning device of claim 8, wherein the evaluation metrics include a first evaluation metric, and
the first evaluation metric is an episode achievement rate that determines whether an episode has been achieved depending on whether a difference between the final health of the enemy unit at the end of each episode and the desired health of the enemy unit is within the preset allowable margin.

10. The learning device of claim 8, wherein the evaluation metrics include a second evaluation metric, and
the second evaluation metric is a desired health error rate based on a difference between the desired health of the enemy unit per episode and the final health of the enemy unit.

11. The learning device of claim 8, wherein the evaluation metrics include a third evaluation metric, and
the third evaluation metric is an ammunition usage cost according to an amount of ammunition used by the friendly unit per episode.

12. The learning device of claim 8, wherein the evaluation metrics include a fourth evaluation metric, and
the fourth evaluation metric is an ammunition efficiency calculated based on whether the episode determined depending on whether a difference between the final health of the enemy unit at the end of each episode and the desired health of the enemy unit is within the preset allowable margin and the ammunition usage amount of the friendly unit upon achievement of the episode.

13. The learning device of claim 2, further comprising:
an evaluation module configured to evaluate performance of the trained neural network through preset first to fourth evaluation metrics,
wherein the first evaluation metric is an episode achievement rate that determines whether an episode has been achieved depending on whether a difference between the final health of the enemy unit at the end of each episode and the desired health of the enemy unit is within a preset allowable margin,
the second evaluation metric may be a desired health error rate based on a difference between the desired health of the enemy unit per episode and the final health of the enemy unit,
the third evaluation metric may be an ammunition usage cost according to an amount of ammunition used by the friendly unit per episode, and
the fourth evaluation metric may be an ammunition efficiency calculated based on whether the episode determined depending on whether a difference between the final health of the enemy unit at the end of each episode and the desired health of the enemy unit is within the preset allowable margin and the ammunition usage amount of the friendly unit upon achievement of the episode.

14. A learning method that is performed on a computing device that includes one or more processors and a memory storing one or more programs executed by the one or more processors and is for military decision-making based on offline reinforcement learning, the learning method comprising:
acquiring enemy-related information and friendly-related information at each time step in each episode;
generating a data set including a state, an action, and a reward based on the enemy-related information and friendly-related information of each time step; and
training a neural network based on reinforcement learning by inputting a data set including the state, action, and reward for each time step.

15. A computer program stored in a non-transitory computer readable storage medium, wherein the computer program includes one or more instructions, and the instructions, when executed by a computing device including one or more processors, cause the computing device to perform:
acquiring enemy-related information and friendly-related information at each time step in each episode;
generating a data set including a state, an action, and a reward based on the enemy-related information and friendly-related information of each time step; and
training a neural network based on reinforcement learning by inputting a data set including the state, action, and reward for each time step.
